(19) United States
(12) Patent Application Publication
(10) Pub. No.: US 2012/0312178 A1
(43) Pub. Date: Dec. 13, 2012

(54) METHOD AND APPARATUS FOR CONDITIONING A DAMPENING SOLUTION FOR HARDNESS CONTROL

(75) Inventors: DIETGER HESEKAMP, Paderborn (DE); ROBERT HOLTWICK, Telgte (DE); THOMAS WOLF, Heidelberg (DE); ALEXANDER GRAF, Heidelberg (DE)

(73) Assignee: HEIDELBERGER DRUCKMASCHINEN AG, Heidelberg (DE)

(21) Appl. No.: 13/525,520

(22) Filed: Jun. 18, 2012

Related U.S. Application Data
(63) Continuation of application No. PCT/EP2010/007574, filed on Dec. 13, 2010.

(30) Foreign Application Priority Data
Dec. 18, 2009 (DE) 10 2009 058 852.3

(51) Int. Cl. B41F 1/66; B41L 25/00

(52) U.S. Cl. 101/147; 101/484

(57) ABSTRACT

A method and an apparatus for conditioning a dampening solution of a wet offset printing machine, include keeping constant or changing the hardness of the dampening solution added to a container during processing of a print job. The hardness of the dampening solution is determined by measuring the conductivity of the dampening solution and is converted into a hardness value according to a determined formula-based or table-based relationship between the hardness and the conductivity of the dampening solution. The change of the hardness of the dampening solution is compensated for during printing by replacing used or withdrawn dampening solution with dampening solution that has a lower or higher hardness, wherein the amount and/or the degree of hardness of the supplied dampening solution having lower or higher hardness is determined from the conductivity measurements and the formula-based or table-based relationship.

### CROSS-REFERENCE TO RELATED APPLICATION

This is a continuation, under 35 U.S.C. §120, of copending International Application No. PCT/EP2010/007574, filed Dec. 13, 2010, which designated the United States; this application also claims the priority, under 35 U.S.C. §119, of German Patent Application DE 10 2009 058 852.3, filed Dec. 18, 2009; the prior applications are herewith incorporated by reference in their entirety.

### BACKGROUND OF THE INVENTION

### Field of the Invention

The present invention relates to a method and an apparatus for conditioning a dampening solution of a wet offset printing press.

A number of process agents are used in printing presses. For example, in addition to the printing ink, offset printing presses which are operated by using the wet offset process require process water, so-called dampening solution or dampening water. The dampening solution which is used is intended to wet the non-printing locations of the printing plate and thus to prevent ink from being accepted in those regions.

An established composition of dampening solution is a proportion of more than 80% by volume water, up to 10% by volume chemical additives and up to 15% by volume isopropanol.

Accordingly, the greatest proportion of the dampening solution is formed by water. The water hardness and therefore the hardness of the dampening solution depend substantially on the calcium and magnesium proportion.

The chemical additives serve, inter alia, to reduce the surface tension to a range which is favorable in terms of printing technology, containment of the formation of microorganisms through the use of biocides, prevention of corrosion on steel components of the printing press through the use of corrosion inhibitors, etc. The isopropanol has, inter alia, the effect of increasing the viscosity and reducing the surface tension. Isopropanol is more volatile than other dampening solution constituent parts, so that the result can be a change in the mixing ratio in the dampening solution as a result of nonuniform evaporation of isopropanol and other dampening solution constituent parts, in particular at relatively high temperatures.

The dampening solution composition, in particular the proportion of isopropanol, therefore firstly has to be monitored and readjusted correspondingly. Secondly, an attempt is made to keep the dampening solution temperature as low as possible, in order to avoid excessive evaporation of isopropanol. As a rule, the dampening solution is therefore cooled to a temperature in the region of T=10° C. In the case of so-called “alcohol-free” printing, alcohol substitutes which bring about a reduction in the surface tension are added to the dampening water instead of the isopropanol.

In dampening solution circuits, conditioning systems are usually provided, in which, for example, floating particles are filtered out, the isopropanol proportion is checked and set, and in which the dampening solution has its temperature controlled.

Another property of the dampening solution which is important for the printing quality is the pH value of the dampening solution.

European Patent Application EP 1 577 117 A2, corresponding to U.S. Pat. No. 7,449,108, has disclosed a method for improving the properties of dampening water in offset printing, in which method the conductivity and the pH value are held at predefined values by the addition of acidic hardeners during the printing. The document does not contain any details as to how manipulated variables are to be determined for the addition of the hardeners.

According to European Patent EP 325 046 B1, corresponding to U.S. Pat. No. 4,917,806, the pH value and the conductivity of dampening water are set, by ion exchanger resins and the dampening water being mixed in a container. The conductivity and the pH value are measured continuously by way of sensors. The inflow quantities of the resins are set by using the measured values. Details about determining the manipulated variables are not disclosed.

U.S. Patent Application Publication No. US 2004/002 5723 A1 describes a dampening solution supply having a mixing chamber of a metering pump. At least two concentrated solutions and dampening water are fed to the mixing chamber. The pH value, the conductivity and the surface tension of the mixed dampening solution are monitored, which is not described in greater detail.

Relatively new information has shown that it is less the conductivity and more the hardness of the dampening water which is decisive for a stable printing process.

Water hardness is a system of concepts of applied chemistry, which system has developed from the requirements of the use of natural water with its dissolved ingredients. For example, water hardness denotes the equivalent concentration of those ions of the alkaline earth metals which are dissolved in the water, but also in special contexts of their anionic partners. Calcium and magnesium and traces of strontium and barium belong substantially to the “hardness formers.” The dissolved hardness formers can form insoluble compounds, above all calcium carbonate and so-called lime soaps. That tendency to form insoluble compounds is the reason for the attention which has led to the creation of the expression and the theory system of water hardness.

An excessively high hardness of the dampening solution can cause problems during printing. For example, deposits of calcium carbonate can cause so-called blind running of the inking rolls, can cause deposits on the rubber blanket or can clog the lines in the dampening solution circuit.

Blind running of the inking rolls is usually understood to mean that certain regions of the inking rolls absorb no printing ink or less printing ink than desired. That can be the case, for example, when calcium salts such as calcium carbonate, calcium citrate or similar substances are deposited on the inking rolls, with the result that the surface of the inking rolls becomes ink repellent in those regions.

Furthermore, the calcium carbonate proportions of the water can also influence the pH value and the electrical conductivity of the dampening solution. Furthermore, the pH value and the conductivity are also influenced by corresponding dampening solution additives, and by the alcohol substitutes in the case of alcohol-free printing. However, an excessively low hardness of the dampening solution also has a negative effect on the printing process. That is because, in that case, the dampening solution can become too “aggressive” and have, for example, corrosive properties. In the ideal case, the dampening solution has a water hardness of from 8° dH to 12° dH (German hardness) and a pH value of from 4.8 to 5.5.

Since the determination of the hardness of the dampening solution on the basis of dampening solution additives proves to be difficult, in the prior art the water hardness is determined before the addition of additives. In that case, for example, test strips are used to determine the overall hardness. The best-known practicable determination method for the overall hardness is the complexometric titration with an aqueous solution of the disodium salt of ethylenediaminetetraacetic acid (EDTA) at a known concentration. EDTA forms soluble, stable chelate complexes with the hardness formers Ca2+ and Mg2+. 100 ml of the water sample to be tested are mixed with 2 ml of 25% ammonia solution, a pH 11 buffer (ammonia-ammonium acetate) and the indicator Eriochrome Black T. The indicator can usually be obtained together with the buffer as so-called “indicator buffer tablets.” The indicator forms a red colored complex with the Ca2+ and Mg2+. If these ions are bound by the EDTA at the end of the titration, the Eriochrome Black T is present in free form and is green colored. The overall hardness is calculated from the used ml of EDTA solution. In a water sample of 100 ml, 1 ml of used EDTA solution (c=0.1 mol/l) corresponds to 5.6° dH (German hardness degrees), That corresponds to 1 mmol/l of alkaline earth ions.

The carbonate hardness is determined by the hydrochloric acid binding capability (HABC). To this end, for example, 100 ml of the water are titrated with hydrochloric acid (c=0.1 mol/l) until the pH value of 4.3 (pH meter or transition of methyl orange indicator). In this case, (virtually) all the carbonate and hydrogen carbonate is converted to “free carbon dioxide.” The acid consumption in ml therefore corresponds to the hydrogen carbonate concentration in mval/l. Multiplication by 2.8 results in German hardness degrees (° dH).

It is furthermore known in the laboratory area to measure the hardness with the aid of ion-selective electrodes. That method has been proposed in German Patent Application DE 10 2008 061 408 A1, corresponding to U.S. Patent Application Publication No. US 2009/0188401, for determining the hardness of the dampening water, and a device for dampening solution conditioning by changing the hardness is described in that document and European Patent Application EP 2 070 697 A1.

A finally prepared dampening solution with the desired dampening solution hardness, the desired pH value and the corresponding additives is usually filled into a dampening solution storage container and is fed from the latter into the dampening solution circuit of a printing press. However, one problem resides in keeping the properties of the prepared dampening solution and, in particular, the water hardness constant during printing. That is because hardness forming ions pass out of the paper coating and out of the printing ink itself through the rolls of the dampening unit into the dampening water circuit, with the result that the hardness of the dampening water rises during the printing process as a function of the paper being used, the inks, the printing speed, etc. Despite the addition of fresh dampening water, the hardness of the dampening solution thus converges in the direction of a very much higher value and can easily reach values in the range between 20° and 30° dH. A stable printing process is no longer possible at those degrees of hardness.

In a method for conditioning dampening solution for an offset printing press according to German Patent Application DE 10 2008 061 408 A1, corresponding to U.S. Patent Application Publication No. US 2009/0188401, the pH value and the hardness of the dampening solution are measured through the use of sensors. If the measured hardness value exceeds a limiting value, a cation exchanger is activated. The dampening solution volume which is to flow through the cation exchanger is defined as a function of the measured water hardness and the desired hardness setpoint value. During a reduction phase of the dampening solution hardness, the hardness is measured more frequently than in a phase, in which the hardness lies in a desired range. In one variant, the conductance value is additionally measured both in a storage container and in an intermediate reservoir after an ion exchange. However, the hardness of the dampening water is measured directly after the method mentioned in the introduction by ion-selective electrodes or a titration device. However, measurements of that type can be carried out only with great difficulty in the harsh surroundings of a printing press under production conditions in the turbid dampening water in the tank of a running printing press and are not suitable for automating the process of the dampening solution conditioning in the sense of setting and/or regulating to hardness degrees which are optimum for printing.

### SUMMARY OF THE INVENTION

It is accordingly an object of the invention to provide a method and an apparatus for conditioning a dampening solution for hardness control in a wet offset printing press, which overcome the hereinafore-mentioned disadvantages of the heretofore-known methods and apparatuses of this general type and with which a determination of the hardness of the dampening solution is made possible in a simple way, in particular even within the surroundings of a printing press.

With the foregoing and other objects in view there is provided, in accordance with the invention, a method for conditioning a dampening solution in a container of a wet offset printing press. The method comprises:

a) determining a hardness of the dampening solution by measuring and converting a conductivity of the dampening solution into a hardness value according to a predetermined formulaic or tabular relationship between the hardness and the conductivity of the dampening solution; and

b) compensating for a change in the hardness of the dampening solution during printing by replacing used or removed dampening solution with a quantity of dampening solution having a lower or higher degree of hardness;

defining the quantity and/or the degree of hardness of the supplied amount of dampening solution with a lower or higher hardness from the conductivity measurements and the formulaic or tabular relationship, by the steps of:
determining the formulaic relationship between the hardness and the conductivity of the dampening solution, before or during a current print job, by either determining value pairs of conductivity and hardness by targeted hardening or softening of the dampening solution and storing the value pairs, or
routing a predefined quantity of the dampening solution through an ion exchanger and determining and storing a differential relationship between the conductivity increase/reduction and the hardness increase/reduction from the measured conductance values before removal of the dampening solution quantity and after renewed addition of the softened dampening solution quantity.

With the objects of the invention in view, there is also provided an apparatus for conditioning a dampening solution of a wet offset printing press. The apparatus comprises a dampening solution container supplying the dampening units of the printing press, a fresh water feed, a metering unit for dampening solution additives, at least one conductivity sensor for measuring a conductivity of the dampening solution, at least one pump and/or at least one valve for removing dampening solution from the container and returning the dampening solution after a change in hardness of the dampening solution or feeding in dampening solution with a hardness being changed in comparison with a dampening solution hardness in the container, a control device for controlling the at least one pump and/or the at least one valve, and a computing unit receiving measured conductivity values of the at least one conductivity sensor and calculating and storing an actual hardness of the dampening solution during printing from the measured conductivity values according to a formulaic or tabular relationship having been determined by value pairs of conductivity and hardness being determined before a print job or during a current print job by targeted hardening or softening, or routing a predefined quantity of the dampening solution through an ion exchanger and determining and storing a differential relationship between the conductivity increase or reduction and hardness increase or reduction from the measured conductance values before removal of the dampening solution quantity and after renewed addition of the softened dampening solution quantity, the control device configured to actuate the at least one pump and/or the at least one valve according to the calculated hardness value or its deviation from a setpoint hardness value.

According to the invention, the hardness of the dampening solution in the dampening solution storage container is therefore determined for the purpose of conditioning the dampening solution in the sense of keeping the hardness of the dampening solution constant or returning it to the desired value, by the conductivity of the dampening solution being measured and being converted into a hardness value according to a predetermined formulaic or tabular relationship between the hardness and the conductivity of the dampening solution. The increase or decrease in the hardness of the dampening solution during printing can then be compensated for, by used or removed dampening solution being replaced by dampening solution which has a lower or higher hardness. In this case, the quantity and/or the degree of hardness of the supplied dampening solution with a lower or higher hardness are/is defined from the conductivity measurements and the formulaic or tabular relationship. In order to determine that formulaic or tabular relationship, the procedure can be carried out in such a way that value pairs are defined from measured conductivity values and hardness values which are determined in the laboratory, and are then used, after a corresponding conversion, for the hardness regulation. The value pairs can be obtained, for example, in such a way that the dampening solution is hardened or softened in a targeted manner in defined stages. In addition, it is also possible to remove a defined quantity of the dampening solution from the dampening solution reservoir, to soften it in a manner which is guided through an ion exchanger, and to feed it to the dampening solution reservoir again. The associated hardness values can then be determined for the value pairs from the conductivity values which are measured before and after this procedure and from the volumes of dampening solution removed from the dampening solution reservoir and fed back to it again.

When the introduction of hardness forming ions into the dampening water from the printed paper or the printed ink is lower than the introduction of hardness forming ions from the dampening water feed, it is possible to keep the hardness of the dampening solution constant during the printing operation, by the hardness of the inflowing fresh water namely being reduced in a targeted manner at the start of printing below the hardness value which should be present in the dampening solution storage container for the purpose of maintaining optimum printing conditions. In this way, the reduced hardness introduction as a result of the inflowing fresh water which replaces the consumption of the dampening solution then compensates for the introduction of hardness forming ions, for example from the paper coating. The procedure can be carried out in this case in such a way that, in order to set the hardness of the water being fed in, fresh water is mixed with osmosis water in a predefined ratio, or osmosis water is only partially hardened.

In the other case, when the proportion of hardness forming ions from the printed paper or printing ink is greater than the proportion of hardness forming ions in the fresh water feed, dampening solution is expediently removed from the dampening solution storage container, is routed through an ion exchanger and is then fed to the container again. In this case, the quantity of removed dampening solution can be determined from the measured increase in the conductivity and the formulaic or tabular relationship between conductivity and hardness. This measure can take place in addition to the reduction in the hardness in the fresh water feed.

It is expedient to measure the conductivity of the dampening solution at a plurality of locations, namely at least in the dampening solution storage container or in the feed from the container to the dampening unit of the printing press, but likewise in the fresh water supply and optionally also in the return line from the ion exchanger to the dampening solution storage container. In this way, namely firstly the ratio of fresh water to osmosis water can be controlled and, in the other case, the conductance value proportions can be determined which the ion exchanger itself supplies when it replaces the hardness forming ions, for example calcium ions, with other ions which do not contribute to the hardness, such as sodium ions. The proportion of the conductance value and therefore the hardness which the printed paper and the printing ink supply can therefore be separated from the other conductance value proportions, the contribution of which to the hardness can be determined in a laboratory.

Other features which are considered as characteristic for the invention are set forth in the appended claims.

Although the invention is illustrated and described herein as embodied in a method and an apparatus for conditioning a dampening solution for hardness control, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, longitudinal-sectional view of an offset printing press and a diagram of a system for conditioning dampening solution for the offset printing press; and

FIG. 2 is a flow chart of a method for conditioning the dampening solution and calculating a mathematical relationship between conductivity and hardness according to a first exemplary embodiment of the invention.

### DETAILED DESCRIPTION OF THE INVENTION

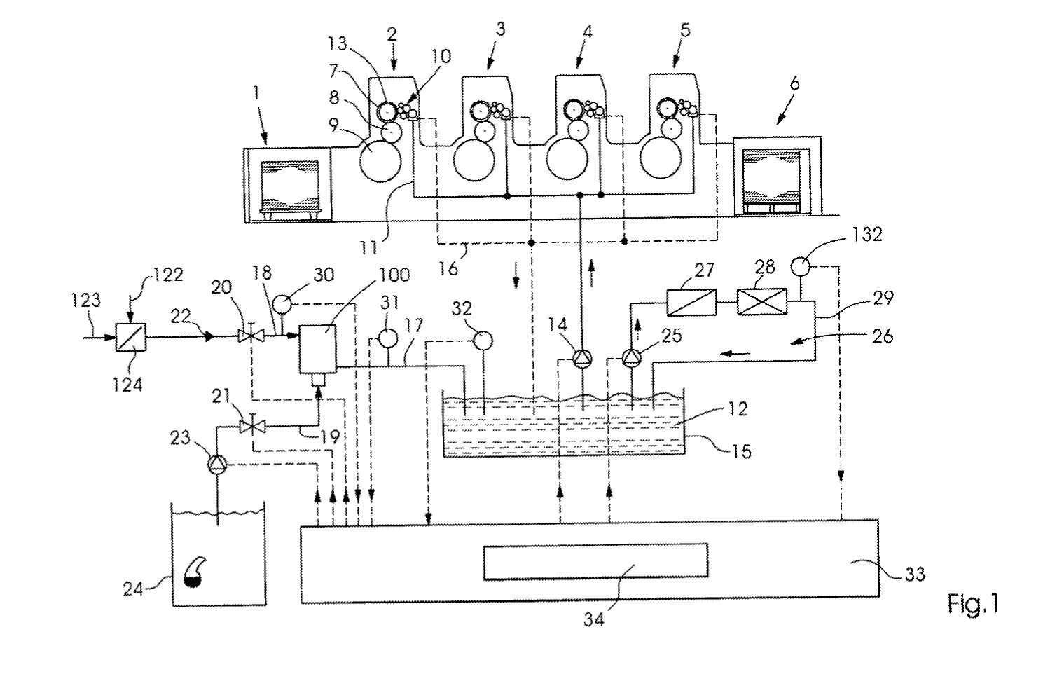

Referring now to the figures of the drawings in detail and first, particularly, to FIG. 1 thereof, there is seen a sheet-fed offset printing press having a feeder 1, four printing units 2 to 5 and a delivery 6. A plate cylinder 7, a transfer cylinder 8 and an impression cylinder 9 are situated in each printing unit 2 to 5. Each plate cylinder 7 is assigned a dampening unit 10. Forward feed lines 11 for a dampening solution 12 lead to the dampening units 10. Non-printing regions of printing forms 13 which are clamped on the plate cylinders 7 are wetted with dampening solution 12 by way of the dampening units 10. The dampening solution 12 is conveyed by way of a pump 14 from a container 15 to the dampening units 10. During printing, unconsumed dampening solution 12 passes from the dampening units 10 through return lines 16 back into the container 15. Consumed dampening solution 12 is refilled through a line 17. A metering unit 100 for the addition of dampening solution additives is inserted into the line 17. A fresh water line leading to the metering unit 100 is denoted by reference numeral 18 and a line for the dampening solution additives is denoted by reference numeral 19. Controllable valves 20, 21 are situated in the lines 18, 19. The valve 20 controls the fresh water inflow and is connected to a corresponding fresh water connection 122. The valve 21 is connected to a pump 23 which conveys dampening solution additives out of a container 24.

The fresh water connection 122 is connected to a mixing valve 124, into which two lines 123, 122 lead. One line 123 is connected to a fresh water inflow which feeds in mains water that has approximately 12° dH. In contrast, the line 122 is connected to a water tank of a non-illustrated reverse osmosis system, in which the tank contains salt-free water which accordingly has 0° dH. As an alternative, the fresh water in the line 122 can also be hardened osmosis water, that is to say water of the hardness 0° dH which has been hardened in a hardening system in a targeted and defined manner to, for example, 12° dH.

An intake line of a further pump 25, which conveys dampening solution (12) into an ion exchanger circuit 26, projects into the container 15. The pump 25 is followed on the pressure side by a fine filter 27 for filtering out dirt, floating particles, etc. and by an ion exchanger 28. The ion exchanger 28 replaces hardness forming calcium and magnesium ions from the dampening solution with sodium ions.

Sensors 30, 31, 32 and 132 for measuring the conductivity of the dampening solution or the liquids flowing through the respective lines are situated in the lines 17 and 18 downstream and upstream of the dampening solution additive metering unit 100, in a return line 29 from the ion exchanger back into the dampening solution storage container 15 and in the dampening solution container itself. The conductivity sensors and control inputs of the valves 20, 21, 124 and the pumps 14, 23, 25 are connected to a control device 33. The control device 33 contains a computer 34 for processing signals of the conductivity sensors 30 to 32, 132 and for generating manipulated variables for the pumps 14, 23, 25 and valves 20, 21, 124.

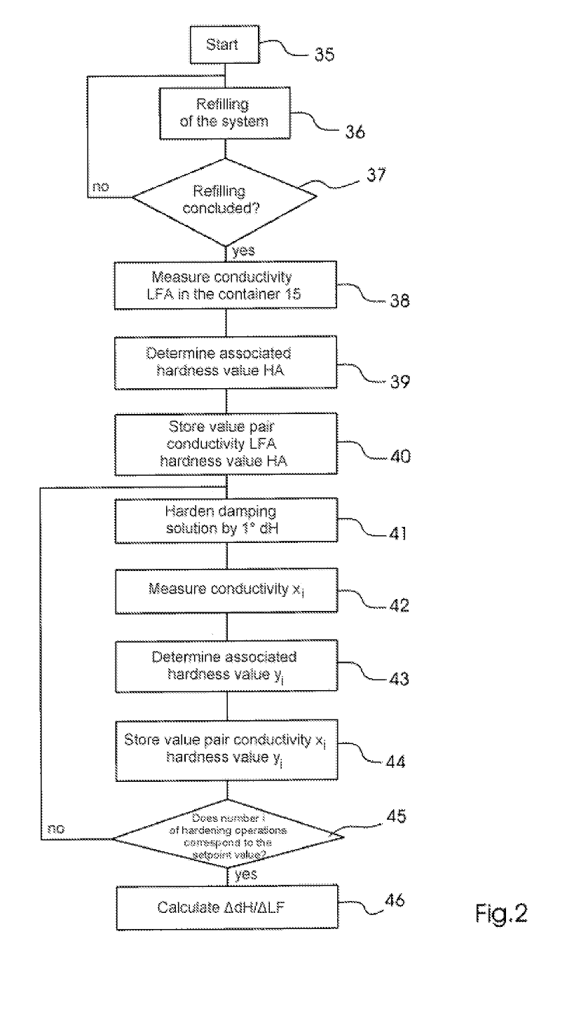

The flow chart in FIG. 2 is used in the following text to describe a first exemplary embodiment of how the dampening solution 12 in the container 15 is conditioned by way of the above-described configuration and the relationship between conductivity LF and hardness dH is calculated.

After a start command has been given in a first step 35, the entire emptied and cleaned system is filled with dampening solution 12 in a next step 36. To this end, the valves 20, 21 are opened and the pumps 14, 23 are set in operation through the use of the control device 33. The mixing valve 124 is set in such a way that fresh water is fed in with a hardness 10° dH.

The conductance value of the fresh water which is measured by the conductivity sensor 30 in the fresh water feed 18 serves as an “incoming inspection,” in order to detect, for example, fresh water which has been set incorrectly with regard to the hardness. There is a relationship at this point that an increase in the hardness by 1° dH leads to a conductance value increase in the order of magnitude of 30 μS/cm. An osmosis water which is hardened to 10° dH as a rule has a conductance value of approximately 300 μS/cm. An additive agent is measured into the water on the order of magnitude of 4% by volume through the use of a metering unit 100. The additives contained therein contribute considerably to the conductivity. Accordingly, this metering leads to a conductance value on the order of magnitude of from 1000 to 1200 μS/cm, depending on the metering and on the additive agent being used itself. That conductance value is measured by the sensor 31. The dampening solution which is freshly conditioned in this way is fed to the dampening solution storage container 15 and is cooled there as a rule to a temperature in the range between 10 and 14° C.

The liquid quantity which is introduced into the system during the first filling operation is measured and a value for the total volume of the dampening solution 12 in the container 15 is stored by the computer 34 of the control device 33.

If the output in an inquiry step 37 is that the refilling operation is concluded, the initial conductivity (LFA) of the dampening solution (12) in the container 15 is possibly measured again for checking purposes by way of the sensor 32 in a following step 38. An associated hardness value (HA) is determined for this measured value (LFA) in a step 39. To this end, the hardness after the titration method mentioned in the introduction is determined and stored. This step can be dispensed with if the hardness of the fresh water feed 18 is known or has been verified through the sensor 30 and the dampening solution additives which are fed in through the line 19 do not contain any hardness forming ions.

In a next step 41, the dampening solution 12 in the container 15 is hardened, for example, in a defined manner in each case by 1° dH. This hardening takes place by defined addition of calcium carbonate and optionally other constituent parts of the paper coating to the dampening solution 12.

After the added calcium carbonate has been mixed well with the dampening solution 12 in the container 15, the conductivity is measured a second time by way of the sensor 32 in the next step 42. The associated hardness values, either calculated from the calcium carbonate addition in relation to the dampening solution volume or measured by titration, are likewise determined (step 43) and are stored with the associated conductivity values (xi) as value pairs (xi, yi) in the control device 33 (step 44). After typically three hardening operations, the number of which is verified by an inquiry step 45, the computer 34 in the control device 33 knows, in addition to the initial value pair (LFA and HA), three further value pairs (xi, yi), from which the mathematical relationship can then be determined for a differential hardness increase in the case of a measured differential conductivity increase (step 46).

This method can have a certain error when the actual rise in the hardness of the dampening water differs during the printing process from the conditions during the hardening, that is to say when, in addition to the calcium carbonate ions, other ions are also introduced into the dampening water from the paper coating through the dampening unit, which ions, although they change the conductivity, do not make any contribution to the hardness. This error can be ruled out if the following procedure is carried out after the filling of the system:

Second alternative: printing is carried out with the newly filled dampening water for a time period, for example until a first stack in the feeder 6 of the printing press has been processed. Subsequently, the conductivity and the hardness of the dampening solution in the container 15 are determined, by firstly the measured conductivity value of the sensor 32 being requested and secondly a sample of the dampening solution being removed and the hardness being determined by titration. The differential relationship between the actual hardness increase and the actual conductivity increase under the conditions of this print job can therefore be calculated exactly and reliably by working out the difference of the second measured value pair from the initial measured values LFA and HA.

A third option for the exact determination of the relationship between the hardness increase and the conductivity increase can be carried out with the aid of the ion exchanger 28 and the bypass line 29, without it also being necessary for a determination of hardness by titration to be carried out during the printing process. This alternative is as follows:

Third alternative: we start from a newly filled dampening solution system which is set, for example, to 10° dH. The initial conductance value LFA which the sensor 32 measures in the container 15 can be divided into two components, into one component LF_{ca} which comes from the hardness forming ions, for example calcium and/or magnesium ions, and into a conductance value component LF_{nH}, coming from ions which do not contribute to the hardness, with the result that the following applies to the conductance value:

LFA=LF_{ca}+LF_{nH} (1)

At 10° dH, LF_{ca} has a value of 300 μS/cm, coming from the known relationship of 30 μS/cm per 1° dH.

The dampening solution is now therefore conveyed through the line 11 to the printing press, a certain amount of the dampening solution is consumed by the printing press and the excess amount which has been conveyed passes through the return line 16 (shown with a dashed line) back into the container 15. However, additional hardness forming ions, principally calcium ions from the paper coating, which pass through the dampening solution rolls of the dampening unit 10 into the dipping baths of the dampening units are now situated in this returned part of the dampening solution. In addition, however, other constituent parts which do not contribute to the hardness but increase the conductance value also pass out of the printing process back into the container 15. As soon as printing has then been carried out for a while, the sensor 32 will report an increased conductance value LF₂, to which the following applies:

LFA=ΔLF_{ca}+ΔLFₛₒₙ=LF₂ (2)

In this case, ΔLF_{ca} are the conductance value proportions added by the printing from hardness forming ions and ΔLFₛₒₙ are the other proportions which do not contribute to the hardness but increase the conductance value, as a result of the printing.

At this instant, the following applies to the hardness:

HA+ΔdH_{ca}=H₂ (3)

Under the assumption that ΔLF_{ca} is comparable with or greater than ΔLFₛₒₙ, a defined quantity 1/n, where n=4, that is to say in the following example a quarter of the dampening solution quantity in the system, is guided through the ion exchanger 28 after a rise in the conductance value by approximately 120 μS/cm, which would correspond roughly to an increase in the hardness by approximately 4° dH.

The ion exchanger softens this quantity, that is to say a quarter of the filling quantity, to 0° dH, with the result that a hardness is set in the system, to which hardness the following applies:

H₃=¾H₂ (4)

At the same time, the ion exchanger 28 replaces the hardness forming ions with, for example, sodium ions.

Measured directly after this partial softening in the container 15, the following applies to the newly measured conductivity value LF₃:

LF₃=¾LF₂+¼(LF₂−[LF_{ca}+ΔLF_{ca}]+LFᵢₒₙ) (5)

The term between parentheses takes into consideration that additional conductivity contributions LFᵢₒₙ as a result of the exchanged sodium ions are added to the measured conductivity LF₂ before the softening, but the conductivity contributions LF_{ca} from the new preparation of the dampening solution and the conductivity contributions, added by the printing, of the hardness forming ions ΔLF_{ca} have been omitted in this softened quarter of the dampening water.

In addition, it is known that the conductivity contributions of the hardness forming calcium ions and of the sodium ions which are emitted by the ion exchanger differ due to the different limiting molar conductivities and are in the ratio a/b. It therefore holds that:

$$\frac{{LF}_{Ca} + Δ {LF}_{ca}}{{LF}_{ion}} = \frac{a}{b} \qquad ( 6 )$$

Inserted into equation 5 and rewritten, the result is equation 7:

$${LF}_{3} = {LF}_{2} - \frac{1}{4} ( 1 - \frac{b}{a} ) \times ( {LF}_{ca} + Δ {LF}_{ca} ) \qquad ( 7 )$$

This can be solved for ΔLF_{ca} and the result is as follows:

$$\frac{( {LF}_{2} - {LF}_{3} )}{\frac{1}{4} ( 1 - \frac{b}{a} )} - {LF}_{ca} = Δ {LF}_{ca} , \qquad ( 8 )$$

the result of which, by inserting the measured values LF₂ and LF₃ and the 300 μS/cm for LF_{ca}, is directly that proportion of the hardness forming ions added by the printing which contributes to the conductance value ΔLF_{ca}. The known relationship of 30 μS/cm per 1° dH applies again to this proportion ΔLF_{ca} which has been separated from the other variable conductance value contributions, with the result that the rise in the hardness until the beginning of the softening operation can be calculated very accurately from it.

In contrast, the factor

$$( 1 - \frac{b}{a} )$$

is characteristic for the ion exchanger being used.

For the case of an ion exchanger which replaces the Ca²⁺ ions with sodium ions,

$$b = 50.1 \frac{S \times {cm}^{2}}{mol} and a = 59.9 \frac{S \times {cm}^{2}}{mol} and ( 1 - \frac{b}{a} ) is therefore 0.16 .$$

Accordingly, the hardness which is then reduced by the softening operation for a quarter of the volume of the dampening solution can subsequently be determined by a simple rule of proportion. If we assume that ΔLF_{ca} would result in 3° dH which is added to the 10° dH by the printing until the start of the softening operation, the dampening solution would therefore have a hardness of ¾×13° dH= 39/4° dH, that is to say approximately 10° dH again, after the softening operation. If, in contrast, the result after the softening is above or below this value, the next softening operation can be initiated earlier or later or the proportion of the dampening solution quantity which is routed through the ion exchanger 28 can be increased or decreased.

This alternative 3 presupposes a volumetric measurement of the dampening solution stream which is routed through the bypass line 29. This is readily possible, however, by the use of corresponding metering pumps 25 or flow meters. A fourth alternative option provides attaching a further conductivity sensor 132, shown by dashed lines in FIG. 1, at the outlet of the ion exchanger 28 and additionally measuring the conductivity directly at the outlet of the ion exchanger 28, before the softened volumetric flow is mixed with the remaining dampening solution in the container 15. The procedure in this case would be as follows:

Fourth alternative: as shown in the preceding third example, as soon as the conductivity sensor 32 signals a rise in the conductance value by, for example, 120 μS/cm, which rise indicates that the hardness of the dampening solution is moving out of the optimum range for printing, the pump 25 is actuated and dampening solution starts to be driven through the filter 27 and the ion exchanger 28. After a short dead time of a few seconds, during which the dampening solution which is perhaps still present from the last softening operation in the filter and in the ion exchanger has been driven past the sensor 132, the sensor 132 begins to measure and now measures a conductivity LF₄ in the stream through the line 29. It holds in this case that:

LF₄=LF₂−(LF_{ca}+ΔLF_{ca})+LFᵢₒₙ (9)

The measured value LF₄ differs from the previously discussed measured value LF₃ which the sensor 32 detects, since the latter does not notice the effect of the ion exchanger 28 until significant parts of the dampening solution have already been softened by the ion exchanger 28. It therefore applies to the conductance value in the line 29, after rewriting and insertion of the relationship already explained in example 3 between LFᵢₒₙ and (LF_{ca}+ΔLF_{ca}) in equation 6 for the hardness-dependent conductance value contributions ΔLF_{ca}:

$$\frac{{LF}_{2} - {LF}_{4}}{( 1 - \frac{b}{a} )} - {LF}_{ca} = Δ {LF}_{ca} \qquad ( 10 )$$

In this case too, ΔLF_{ca} can be calculated directly, namely by inserting the measured values LF₄ from the sensor 132 and LF₂, that is to say the measured value of the sensor 32 shortly before the beginning of the softening operation. A volumetric consideration is not required at this point.

In order to return the hardness in the dampening solution system to the initial hardness, merely the hardness contribution ΔLF_{ca} has to be compensated for. This takes place by requesting the measured value of the sensor 32 which, during the softening operation which then continues, reports permanently falling or rising conductance values, depending on which ions the ion exchanger uses to replace the hardness forming ions. The controller 33 will let the pump 25 run in this case until the computer 34 reports that the measured values of the sensor 32 currently lie by ΔLF_{ca} below or above the last conductance value ΔLF₂ which was measured before the softening operation. As soon as this state has been reached, the pump 25 is switched off by the controller 33, the last-measured conductance value LF₂−ΔLF_{ca} is correlated as the new starting value LFAₙₑᵤ with the setpoint hardness which has now been reached again of 10° dH and, during the continuous printing, the sensor 32 is again interrogated as to when the conductance value increase which is continuing due to the introduction of hardness forming ions requires a new softening cycle.

The above-described example with the additional conductivity sensor 132 is suitable in a special way for substantially increasing the service life of the ion exchanger 28, by carrying out the following procedure:

### Example 5

at the beginning of continuous printing, the inflow of fresh water is switched over to osmosis water through the valve 123, that is to say flowing fresh dampening water is produced by the osmosis water from the line 122 being provided with dampening solution additives through the metering unit 100 and afterward being fed to the container 15 through the line 17. No hardness forming ions are situated in this freshly flowing dampening solution. Accordingly, the hardness of the dampening solution in the container 15 will be maintained solely by the hardness forming ions, for example calcium ions, which come from the dipping baths of the dampening units 10 through the return line 16 and have migrated into the dampening water.

The computer 34 then determines at certain intervals by brief actuation of the pump 25 with simultaneous interrogation of the sensors 32 and 132 how the measured conductivity values LF₂ and LF₄ of the two sensors 32 and 132 (see equation 10) have developed and derives therefrom whether the value calculated from it for ΔLF_{ca} exhibits lower but still positive values or whether ΔLF_{ca} tends toward zero or even changes its mathematical sign. In the latter case, this indicates a negative introduction of hardness forming ions, that is to say more calcium is consumed or printed through the dampening solution than is resupplied through the lines 17 and 16. In this case, the controller 33 would actuate the mixing valve 124 and then, in addition to the osmosis water through the line 122, also mix in harder water through the line 123.

In the other case, which will be the more frequent case according to the empirical values, more hardness forming ions will still be fed into the dampening solution system by the printing press than can be printed. Then the softening cycles mentioned in above-described example 4 are still to be carried out, but they are to be carried out at greater intervals, as a result of which the service life of the ion exchanger 28 can be extended considerably.

1. A method for conditioning a dampening solution in a container of a wet offset printing press, the method comprising the following steps:
a) determining a hardness of the dampening solution by measuring and converting a conductivity of the dampening solution into a hardness value according to a predetermined formulaic or tabular relationship between the hardness and the conductivity of the dampening solution; and
b) compensating for a change in the hardness of the dampening solution during printing by replacing used or removed dampening solution with a quantity of dampening solution having a lower or higher degree of hardness;
defining the quantity and/or the degree of hardness of the supplied amount of dampening solution with a lower or higher hardness from the conductivity measurements and the formulaic or tabular relationship, by the steps of:
determining the formulaic relationship between the hardness and the conductivity of the dampening solution, before or during a current print job, by either determining value pairs of conductivity and hardness by targeted hardening or softening of the dampening solution and storing the value pairs, or
routing a predefined quantity of the dampening solution through an ion exchanger and determining and storing a differential relationship between the conductivity increase/reduction and the hardness increase/reduction from the measured conductance values before removal of the dampening solution quantity and after renewed addition of the softened dampening solution quantity.

2. The method according to claim 1, which further comprises reducing a hardness of fresh water being fed in below a setpoint value of a hardness to be set in the container, if an introduction of hardness forming ions into dampening water from printed paper or printed ink is lower than an introduction of hardness forming ions from a dampening solution feed at the setpoint value.

3. The method according to claim 2, which further comprises setting the hardness of the water being fed in by mixing fresh water with osmosis water in a predefined ratio or not hardening or only partially hardening the osmosis water.

4. The method according to claim 1, which further comprises:
if a proportion of hardness forming ions from printed paper or printing ink is greater than a proportion of hardness forming ions in a fresh water feed at a setpoint value of a hardness to be set in the container:
removing dampening solution from the container, routing the dampening solution through an ion exchanger and then feeding the dampening solution to the container again; and
determining a quantity of the dampening solution to be removed from the measured increase in the conductivity and the formulaic or tabular relationship.

5. The method according to claim 4, which further comprises reducing a hardness of the fresh water being fed in below the setpoint value in addition to the steps of removing dampening solution from the container, routing the dampening solution through the ion exchanger and feeding the dampening solution to the container again.

6. The method according to claim 4, which further comprises measuring the conductivity of the dampening solution at a plurality of locations including at least in the container or in a feed from the container to a dampening unit of the printing press and in a return flow line from the ion exchanger to the container.

7. The method according to claim 6, which further comprises additionally measuring the conductivity of the dampening solution in a fresh water feed line.

8. The method according to claim 5, which further comprises measuring the conductivity of the dampening solution at a plurality of locations including at least in the container or in a feed from the container to a dampening unit of the printing press and in a return flow line from the ion exchanger to the container.

9. The method according to claim 8, which further comprises additionally measuring the conductivity of the dampening solution in a fresh water feed line.

10. The method according to claim 6, which further comprises determining a proportion of hardness forming ions coming from printed paper or printing ink from a comparison of measured conductivity values at various locations.

11. The method according to claim 8, which further comprises determining a proportion of hardness forming ions coming from printed paper or printing ink from a comparison of measured conductivity values at various locations.

12. The method according to claim 4, which further comprises taking measured values of a sensor measuring the conductivity of the dampening solution in the container and volumes of the dampening solution routed through the ion exchanger and of all dampening solution/h contained in the container and in a dampening solution circuit into consideration in order to calculate a hardness of the dampening solution in the container after a softening cycle.

13. The method according to claim 4, which further comprises determining proportions supplied by the ion exchanger to the conductance value in a manner specific to the ion exchanger and using the proportions to calculate conductance value proportions originating from an introduction of hardness forming ions from printed paper and/or ink.

14. An apparatus for conditioning a dampening solution of a wet offset printing press having dampening units, the apparatus comprising:
a dampening solution container supplying the dampening units of the printing press;
an ion exchanger connected to said container;
a fresh water feed;
a metering unit for dampening solution additives being connected between said fresh water feed and said container;
at least one conductivity sensor for measuring a conductivity of the dampening solution;
at least one of at least one pump or at least one valve for removing dampening solution from said container and returning the dampening solution after a change in hardness of the dampening solution or feeding in dampening solution with a hardness being changed in comparison with a dampening solution hardness in said container;
a control device for controlling at least one of said at least one pump or said at least one valve; and
a computing unit:
receiving measured conductivity values of said at least one conductivity sensor and calculating and storing an actual hardness of the dampening solution during printing from the measured conductivity values according to a formulaic or tabular relationship having been determined by value pairs of conductivity and hardness being determined before a print job or during a current print job by targeted hardening or softening, or
routing a predefined quantity of the dampening solution through said ion exchanger and determining and storing a differential relationship between the conductivity increase or reduction and hardness increase or reduction from the measured conductance values before removal of the dampening solution quantity and after renewed addition of the softened dampening solution quantity;
said control device configured to actuate at least one of said at least one pump or said at least one valve according to the calculated hardness value or its deviation from a setpoint hardness value.
